(19) United States
(12) Patent Application Publication
(10) Pub. No.: US 2026/0180725 A1
(43) Pub. Date: Jun. 25, 2026

(54) METHODS TO HANDLE VARIABLE RANK REPORTING FOR EIGENVECTOR-BASED TEMPORAL-SPATIAL-FREQUENCY COMPRESSION

(71) Applicant: InterDigital Patent Holdings, Inc., Wilmington, DE (US)

(72) Inventors: Mohamed Salah Ibrahim, Chesterbrook, PA (US); Mihaela Beluri, Jericho, NY (US); Patrick Tooher, Montreal (CA); Zihao You, Brooklyn, NY (US); Keya Patani, London (GB)

(73) Assignee: InterDigital Patent Holdings, Inc., Wilmington, DE (US)

(21) Appl. No.: 18/988,180

(22) Filed: Dec. 19, 2024

(51) Int. Cl. H04L 1/1829; H04B 7/06; H04L 1/1867; H04L 5/00

(52) U.S. Cl. CPC H04L 1/1835; H04B 7/0626; H04L 1/1874; H04L 5/0048

(57) ABSTRACT

A method may be performed by a wireless transmit/receive unit (WTRU), including receiving a temporal-spatial-frequency (TSF) buffer configuration associated with multi-layer buffer management for a plurality of buffers for eigenvector-based TSF CSI compression. The TSF buffer configuration may include a plurality of TSF buffer actions and conditions associated with the plurality of TSF buffer actions. Channel state information (CSI) reference signal (RS) transmissions associated with one or more transmission layers may be received. The plurality of buffers may be updated based on the CSI-RS transmissions. A TSF buffer action may be determined for each of the plurality of buffers based on the TSF buffer configuration. An indication of the TSF buffer action for each of the plurality of buffers may be sent.

### BACKGROUND

A Channel State Information (CSI) feedback report may include multiple components, and may be reported in multiple parts. A key component in the feedback information may be the precoding matrix index (PMI) which can be referred to as a codeword index in the codebook, and may dominate the overhead associated with the feedback report. A codebook may include a set of precoding vectors and/or matrices for each rank and a number of antenna ports. Each precoding vectors and/or matrices may have its own index so that a receiver may inform preferred precoding vector and/or matrix index to a transmitter. The codebook-based precoding may have performance degradation due to its finite number of precoding vectors and/or matrixes as compared with non-codebook-based precoding. However, an advantage of a codebook-based precoding may be lower control signaling and/or feedback overhead.

### SUMMARY

A wireless transmit/receive unit (WTRU) may include a processor. The processor may be configured to receive a temporal-spatial-frequency (TSF) buffer configuration associated with multi-layer buffer management for a plurality of buffers for eigenvector-based TSF channel state information (CSI) compression. The TSF buffer configuration may include a plurality of TSF buffer actions and conditions associated with the plurality of TSF buffer actions. The plurality of TSF buffers may include one or more per-layer TSF buffers. CSI-reference signal (RS) transmissions associated with one or more transmission layers may be received. The plurality of buffers may be updated based on the CSI-RS transmissions. A TSF buffer action may be determined for each of the plurality of buffers based on the TSF buffer configuration. An indication of the TSF buffer action for each of the plurality of buffers may be sent.

The TSF buffer configuration may include TSF buffer monitoring parameters, and the processor may be configured to update the plurality of buffers based on the CSI-RS transmissions and the TSF buffer monitoring parameters.

The TSF buffer monitoring parameters may include a buffer monitoring priority associated with the plurality of buffers or assistance information that indicates an output of a network action associated with network-side TSF buffer information.

The plurality of TSF buffer actions may include a reset action and at least one of an active update action, a truncate action, or a drop action. The processor may be configured to flush stored samples in each of the plurality of buffers to perform the reset action, and to incorporate newly received CSI samples into each of the plurality of buffers, wherein previously stored samples may be retained, to perform the active update action. The processor may be configured to remove one or more oldest samples from each of the plurality of buffers to perform the truncate action, and to remove one or more selected samples from each of the plurality of buffers, wherein the removed samples may not be the one or more oldest samples, to perform the drop action.

The processor may be configured to send the indication of the TSF buffer action for each of the plurality of buffers periodically or upon detecting a change in the TSF buffer actions.

The conditions associated with the plurality of TSF buffer actions may include at least one of a minimum correlation or normalized mean square error (NMSE) threshold between each pair of contiguous samples in each of the plurality of buffers, a minimum correlation or NMSE threshold between a first sample and a last sample in each of the plurality of buffers, a minimum or maximum temporal distance between each pair of samples in each of the plurality of buffers, a spacing type for samples in each of the plurality of buffers, wherein the spacing type is uniform or non-uniform, a number of inactive instances to trigger a reset action for one or more of the plurality of buffers, one or more metrics for a first layer TSF buffer; or a reference signal received power (RSRP) or signal-to-interference-plus-noise ratio (SINR) threshold associated with each of the plurality of buffers.

The processor may be configured to determine the plurality of TSF buffer actions based on at least one of a correlation threshold between contiguous samples in the plurality of TSF buffers, a correlation threshold between first and last samples in the plurality of TSF buffers, a configured spacing type for samples in the plurality of TSF buffers, wherein the spacing type is uniform or non-uniform, or a number of inactive instances associated with the plurality of TSF buffers.

The processor may be configured to update the plurality of TSF buffers by at least one of truncating one or more oldest samples in the plurality of TSF buffers, or dropping one or more selected samples in the plurality of TSF buffers, wherein the selected samples may not be the oldest samples.

The processor may be configured to report the TSF buffer action periodically, at a configured interval, and to report the TSF buffer action upon determining a change in a TSF buffer action for at least one layer.

The processor may be configured to multiplex the TSF buffer action with a TSF compressed report.

A method may be performed by a wireless transmit/receive unit (WTRU), including receiving a temporal-spatial-frequency (TSF) buffer configuration associated with multi-layer buffer management for a plurality of buffers for eigenvector-based TSF CSI compression. The TSF buffer configuration may include a plurality of TSF buffer actions and conditions associated with the plurality of TSF buffer actions. Channel state information (CSI) reference signal (RS) transmissions associated with one or more transmission layers may be received. The plurality of buffers may be updated based on the CSI-RS transmissions. A TSF buffer action may be determined for each of the plurality of buffers based on the TSF buffer configuration. An indication of the TSF buffer action for each of the plurality of buffers may be sent.

The method may include updating the plurality of buffers based on the CSI-RS transmissions and TSF buffer monitoring parameters, wherein the TSF buffer configuration comprises the TSF buffer monitoring parameters.

The TSF buffer monitoring parameters may include a buffer monitoring priority associated with the plurality of buffers or assistance information that indicates an output of a network action associated with network-side TSF buffer information.

The plurality of TSF buffer actions may include a reset action and at least one of an active update action, a truncate action, or a drop action. The reset action may include flushing stored samples in each of the plurality of buffers. The active update action may include incorporating newly received CSI samples into each of the plurality of buffers, wherein previously stored samples are retained. The truncate action may include removing one or more oldest samples from each of the plurality of buffers. The drop action may include removing one or more samples from each of the plurality of buffers, wherein the removed samples are not the one or more oldest samples.

The method may include sending the indication of the TSF buffer action for each of the plurality of buffers periodically or upon detecting a change in the TSF buffer actions.

The conditions associated with the plurality of TSF buffer actions may include at least one of a minimum correlation or normalized mean square error (NMSE) threshold between each pair of contiguous samples in each of the plurality of buffers, a minimum correlation or NMSE threshold between a first sample and a last sample in each of the plurality of buffers, a minimum or maximum temporal distance between each pair of samples in each of the plurality of buffers, a spacing type for samples in each of the plurality of buffers, wherein the spacing type is uniform or non-uniform, a number of inactive instances to trigger a reset action for one or more of the plurality of buffers, one or more metrics for a first layer TSF buffer; or a reference signal received power (RSRP) or signal-to-interference-plus-noise ratio (SINR) threshold associated with each of the plurality of buffers.

The determining the plurality of TSF buffer actions may include determining the plurality of TSF buffer actions based on at least one of a correlation threshold between contiguous samples in the plurality of TSF buffers, a correlation threshold between first and last samples in the plurality of TSF buffers, a configured spacing type for samples in the plurality of TSF buffers, wherein the spacing type is uniform or non-uniform, or a number of inactive instances associated with the plurality of TSF buffers.

The updating the plurality of TSF buffers may include at least one of truncating one or more oldest samples in the plurality of TSF buffers, or dropping one or more selected samples in the plurality of TSF buffers, wherein the selected samples may not be the oldest samples.

The method may include reporting the TSF buffer action periodically, at a configured interval, or reporting the TSF buffer action upon determining a change in a TSF buffer action for at least one layer.

The method may include multiplexing the TSF buffer action with a TSF compressed report.

Methods and/or WTRU procedures provided herein may be utilized for efficient multi-layer buffer management process for EV-based TSF compression with variable rank reporting. Methods and/or WTRU procedures may be utilized for determining and/or reporting per-layer buffer actions based on one or more measurements (e.g., per-layer buffer related measurements, and/or satisfying a configured criterion).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example Artificial Intelligence/Machine Learning (AI/ML) framework for Channel State Information (CSI) compression.

FIG. 3 is a diagram illustrating an example Temporal-Spatial-Frequency (TSF) compression framework with past precoding matrices used at both a WTRU side and a NW-side.

FIG. 4 is a diagram illustrating an example of temporal behavior of a sequence of correlated samples.

FIG. 5 is a flow diagram illustrating example wireless transmit/receive unit (WTRU) procedures for eigenvector (EV)-based Temporal-Spatial-Frequency (TSF) compression with variable rank reporting.

### DETAILED DESCRIPTION

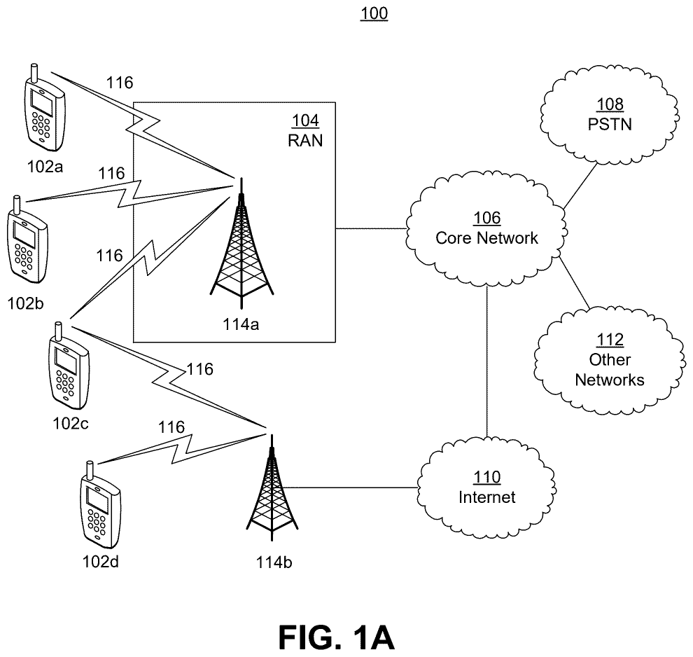

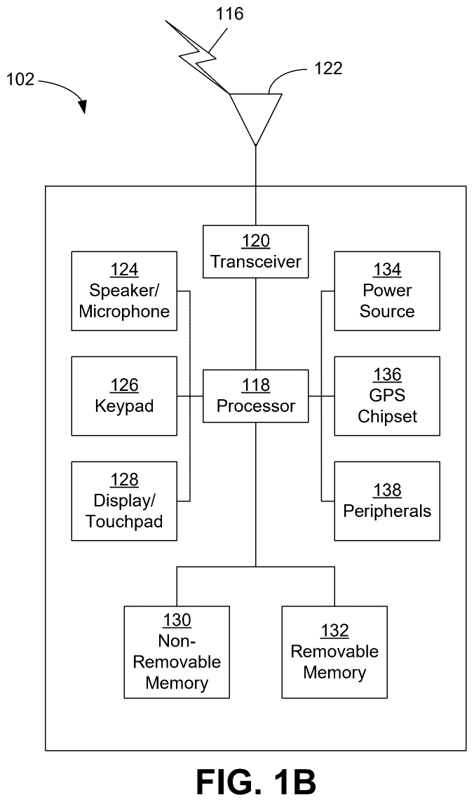

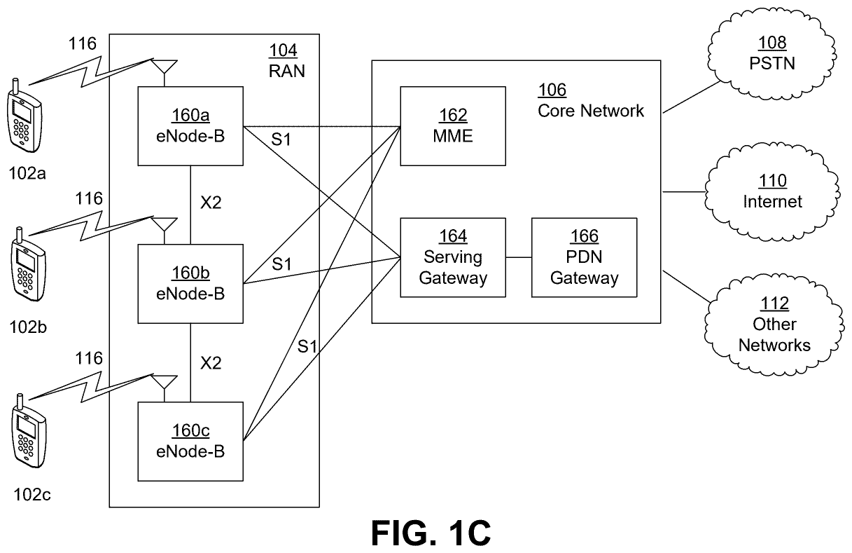

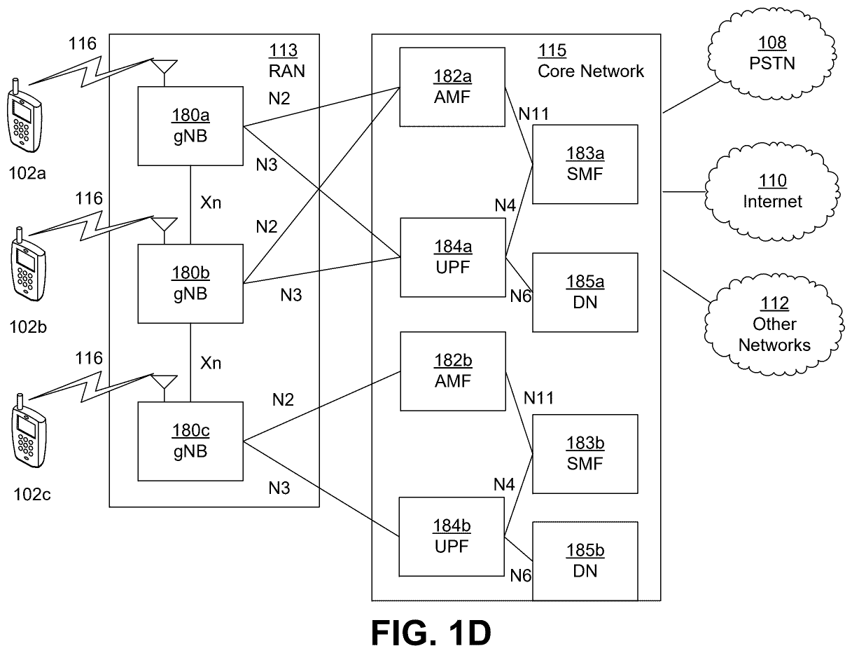

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122.

As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c.

The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

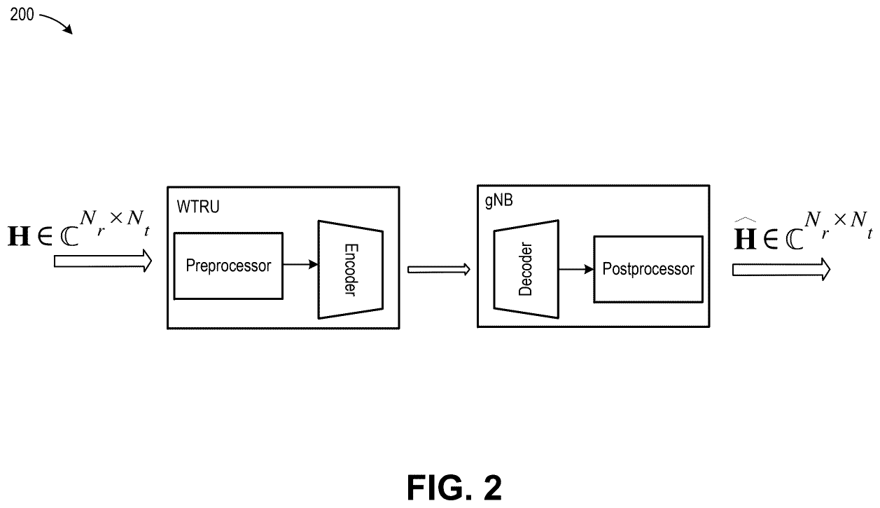

Referring now to FIG. 2, a diagram 200 showing an example Artificial Intelligence/Machine Learning (AI/ML) framework for Channel State Information (CSI) compression is illustratively depicted.

Auto-encoders (AE) may be a specific class of deep neural networks (DNNs) that arise in the context of unsupervised machine learning settings, which may include settings in which the high-dimensional data may be non-linearly transformed to a lower dimensional latent vector using a DNN based encoder, and the lower dimensional latent vector may then used to reproduce the high-dimensional data using a non-linear decoder. The encoder may be represented as E(x; Wₑ), where x is the high-dimensional input data and Wₑ represents the parameters of the encoder. The decoder may be represented as D(z; W_{d}), where z is the low-dimensional latent representation and W_{d} represents the parameters of the decoder.

In examples, the trained encoder E(x; Wₑ) may be used to compress the high-dimensional data and the trained decoder D(z; W_{d}) may be used to decompress the latent representation. The AI/ML framework for CSI compression using AE may include, for example, a pre- and/or post-processor, and/or an AI/ML encoder and/or decoder at the WTRU and gNB-side, respectively, as shown in FIG. 2. The input channel H∈ [symbol] ^{N}^{ᵣ}^{×N}^{ₜ} may first be preprocessed and/or transformed to another domain before being compressed by the AI/ML encoder. The received compressed channel may be then decompressed by the AI/ML decoder and then may be post-processed to be transformed back to the original domain associated with the input channel H.

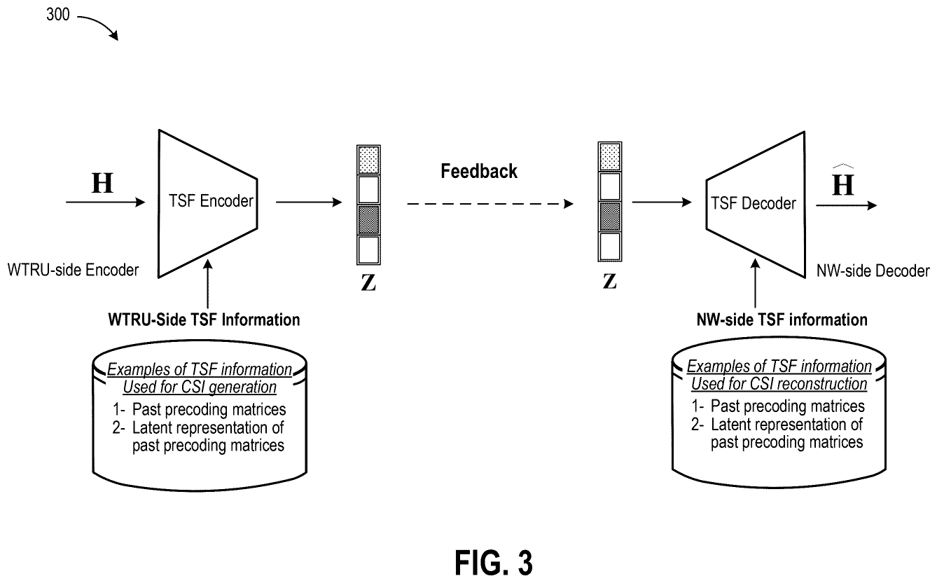

Referring now to FIG. 3, a diagram 300 showing an example Temporal-Spatial-Frequency (TSF) compression framework with past precoding matrices used at both a WTRU side and a NW-side is illustratively depicted.

TSF compression may leverage temporal correlations of CSI samples to improve the compression process relative to spatial-frequency compression. Exploiting the CSI temporal correlation on the top of SF compression has the potential to provide further improvements, including, for example, improvement in the reconstruction performance for a given overhead, reduction in the overhead for a given performance, and/or improvement in both performance and overhead relative to the SF compression. The usage of the past CSI may be enabled at the WTRU-side only, the NW-side only, or both the WTRU-side and the NW-side, as shown in FIG. 3.

The usage of the past CSI at both the WTRU-side and the NW-side may be particularly useful, as it may provide the best performance at least in part due to the temporal correlation being exploited at both communication nodes. However, to leverage the temporal correlation at both sides, the past CSI may need to be synchronized at the WTRU-side and at the NW-side. Otherwise, the performance may be degraded with any missing UCI event. A missing UCI may imply that the CSI report indicated from the WTRU to NW may be dropped or lost, resulting in mis-synchronization between the stored historical samples between the WTRU and the NW. The past CSI may be represented and/or used in different ways by both the WTRU and the NW. The 3GPP RAN1 #118 agreed to consider precoding matrix (e.g., eigenvector (EV) domain, and/or compression for TSF). The terms past CSI and TSF information may be used interchangeably to indicate the historical information or a representation thereof (e.g., EV, used by the WTRU and/or NW in the compression and/or reconstruction processes).

While eigenvector-based compression using AIML models may result in performance improvement (e.g., complexity reduction and/or reconstruction performance improvement) relative to raw channel compression, such compression may include additional challenges as compared to raw channel compression. For example, one challenge in the context of TSF compression may pertain to rank adaptation. For efficient and proper TSF compression operation, the NW-side historical buffer and WTRU-side historical buffer may need to be in-sync and/or may need to consistently have a sufficient number (e.g., at least 50% of the buffer capacity, the configured observation window length, and/or channel coherence time) of historical samples for reliable compression performance. With EV-based TSF compression, the latter requirement may be difficult to achieve because of inconsistencies in the reported rank over time. For example, only the first layer CSI feedback may be continuously reported in every CSI feedback report while other layers may be intermittent. This may cause the first layer buffer operate at full capacity, resulting in efficient TSF compression, while the buffers for the other layers may be reset more frequently to maintain synchronization, which in turn may impact the TSF performance associated with higher layers.

Examples may include enabling an efficient EV-based TSF framework under dynamic rank reporting (e.g., rank adaptation). Buffer reset events for higher rank layers may be reduced, which may result in enhancements in the associated reconstruction performance. Enhancements in performance may be achieved by, for example, enabling efficient EV-based TSF compression under variable rank reporting scenarios; reducing the buffer reset events for higher rank layers TSF compression under variable rank reporting scenarios; determining the buffer status for each of the layers; and/or utilizing correlation information associated with a first layer to assist in the TSF compression and/or decompression of other layers.

There may be a plurality of WTRU procedures utilized for multi-layer buffer management for EV-based TSF compression with rank adaptation. Methods may be implemented for an efficient multi-layer buffer management process to enable EV-based TSF compression with variable rank reporting. A WTRU may perform procedures to determine and/or report per-layer buffer actions based on one or more measurements (e.g., per-layer buffer related measurements, satisfying a configured criterion.

Methods may be implemented for an efficient multi-layer buffer management process to enable eigenvector (EV)-based temporal spatial frequency (TSF) compression with variable rank reporting. A wireless transmit/receive unit (WTRU) may perform procedures to determine and report per-layer buffer actions based on one or more measurements (e.g., per-layer buffer-related measurements) satisfying a configured criterion.

The WTRU may report its capability for precoding vectors (e.g., eigenvectors) based TSF compression. Such a report may include the total number of storage or memory units available for all layers, an indication of the maximum number of storage or memory units per layer, and the maximum number of TSF buffers the WTRU may support, handle, and/or monitor.

The WTRU may receive configuration information for channel state information (CSI) feedback based on TSF compression with past precoding vectors used at both the network (NW) and WTRU during the compression process. This process (e.g., using an AE model), may utilize configuration information. The configuration information may include one or more of the following. For example, the configuration information configuration may include WTRU-side TSF buffer parameter settings, such as, one or more per-layer TSF buffers, where each buffer may be associated with a different layer. TSF buffer parameters may include and/or represent the type of historical precoding vectors (e.g., historical samples) utilized for CSI generation and/or reconstruction. Types of historical samples may represent spatial-frequency domain samples, angular samples, delay domain samples, and/or Doppler domain samples.

Per-layer TSF buffer parameters may include the number and indices of active buffers at the WTRU side, where an active buffer may indicate that the WTRU may actively monitor and/or update the per-layer TSF buffer. The total number of per-layer TSF buffers (denoted as N) may be upper-bounded by the number of receive antennas, based on NW configuration, and/or based on the maximum rank. Parameters may also include the maximum number of historical samples per buffer and/or layer, and/or the default number of active buffers. Per-layer TSF buffer actions may include one or more of the following: an A0 action (reset) to fully flush the buffer; an A1 action (actively update) to continue updating the buffer while observed samples remain useful. These actions may be utilized: to mitigate missing uplink control information (UCI) in various situations. For example, when the WTRU updates the buffer, but a sample is not received or is received erroneously at the NW; for an A2 action (e.g., Truncate), which may include flushing one or more of the oldest samples in the buffer; and/or an A3 action (e.g., drop), which may ignore and/or drop certain samples for some layers, which may not necessarily be the oldest samples.

Per-layer TSF buffer monitoring parameters may ensure proper TSF compression by aligning WTRU-side TSF synchronization information with NW-side TSF synchronization information. These parameters may include buffer monitoring priorities, which may indicate that the WTRU prioritizes certain per-layer TSF buffer(s) over others for monitoring. NW-assistance information may indicate outputs of NW actions associated with one or more NW-side per-layer TSF buffer(s) information. This information may include an indication of the NW-side per-layer TSF buffer actions based on WTRU feedback.

The WTRU may determine its per-layer TSF buffer actions based on received WTRU feedback. Various criteria and/or conditions to determine a WTRU side per-layer TSF buffer action may include, for example, one or more of a minimum correlation or normalized mean square error (NMSE) threshold between pairs of contiguous samples within a per-layer TSF buffer; the minimum correlation or NMSE threshold between the first and last samples in a per-layer TSF buffer; and/or the minimum and/or maximum time distance (in milliseconds) between sample pairs in a per-layer TSF buffer. Criteria and/or conditions may include a spacing type (e.g., uniform, non-uniform, and/or both); the spacing between samples in a per-layer TSF buffer a number of inactive instances to reset; and/or metrics associated with a first-layer TSF buffer (e.g., Layer1 performance, squared generalized cosine similarity (SGCS) between samples associated with first layer buffer, reception quality of first layer, and/or reconstruction under intentionally dropped and/or truncated samples).

The WTRU may also consider a reference signal received power (RSRP) and/or signal-to-interference-plus-noise ratio (SINR) threshold. A reporting configuration may include UL resources for per layer TSF buffer information. The WTRU may receive one or more CSI reference signal (CSI-RS) transmissions and may update the one or more WTRU-side per-layer TSF buffers based on the received one or more CSI-RS transmissions and/or one or more of the configuration parameters (e.g., buffer monitoring priority and/or NW-assistance information). The WTRU may determine one or more per-layer TSF buffer actions (e.g., A0, A1, A2, and/or A3) based on one or more of the following, including the updated one or more WTRU-side per-layer TSF buffer(s) and the received configuration. The WTRU may determine one or more per-layer TSF buffer actions based on, for example, the number of inactive instances for a layer as compared to a threshold and/or based on RSRP and/or SINR measurements (e.g., select A0 in this example case). A selection may be based on, for example, the measured correlation and/or NMSE between the contiguous samples evaluated against a threshold (e.g., select A1 if higher). The WTRU may determine one or more per-layer TSF buffer actions based on the measured correlation and/or NMSE between the first and last samples evaluated against a threshold, and may, for example, select A2 if below a threshold. One or more actions may be selected as a function of the rank pattern (e.g., select A1 if no change in the rank pattern over a period of time, as a function of the configured spacing type (e.g., Uniform and/or non-uniform), and A3 may be selected if, for example, uniform spacing is needed. One or more actions may be selected as a function of the Layer-1 buffer-related measurements (e.g., impact of intentionally dropped samples from the buffer to mimic behavior of other layers, may influence the buffer action determination.

The WTRU may report the determined per-layer TSF buffer actions periodically (e.g., report may be indicated every n configured period); multiplexed with a TSF compressed report (e.g., a TSF compressed report obtained using the updated one or more WTRU-side per-layer TSF buffer(s); when one or more conditions is satisfied (e.g., rank value updates, per-layer performance drops below a threshold; and/or upon change of one or more per-layer TSF buffer action from one or more previously reported per-layer TSF buffer actions.

Methods described herein may be utilized to enable efficient EV-based TSF compression with past CSI (e.g., TSF information) available at both WTRU-side and NW-side under different rank adaptation scenarios, which may enhance one or more buffer management processes for different layers (e.g., reduce the number of buffer resets) to optimize the TSF performance.

The terms Artificial Intelligence (AI), Machine Learning (ML), Deep Learning (DL), and Deep Neural Networks (DNNs) may be used interchangeably. Methods described herein may be exemplified based on learning in wireless communication systems; however, such methods may not be limited to these scenarios, systems, and/or services. These methods may be applicable to various types of transmissions, communication systems, and/or services.

The terms Autoencoder (AE) model, AI/ML model, ML model, and A1 model may be used interchangeably to refer to the model employed for CSI compression.

WTRU procedures may support multi-layer buffer management for eigenvector (EV)-based temporal spatial frequency (TSF) compression with rank adaptation. A WTRU capable of performing TSF CSI compression based on precoding vectors (e.g., eigenvectors) may report its relevant capability to the network (NW). Such reporting may allow the NW to obtain sufficient information to configure and manage multi-layer buffers for precoding vector-based TSF compression with rank adaptation.

In examples, the WTRU capability for reporting may include storage and/or memory information and/or buffer information. For storage and/or memory information, a WTRU may report the total number of its storage and/or memory units that may save historical CSI samples on the WTRU side. Additionally, the WTRU may report whether there are any limits on the number of storage and/or memory units available per layer. If such limits exist, the WTRU may report the maximum storage and/or memory capacity for each layer. This storage and/or memory capability may be required for configuring the per-layer TSF buffers, such as determining the maximum number of historical samples that may be saved in a buffer.

Regarding buffer information, a WTRU may report the maximum storage and/or memory capacity of each buffer and/or the maximum number of per-layer TSF buffers it supports. A WTRU may also report how CSI samples are saved in a buffer, specifying the buffer structure, which may be circular and/or linear. For example, a circular buffer may provide advantages such as more efficient memory utilization and consistent operational complexity compared to a linear buffer. However, due to its fixed size, a circular buffer may make it more challenging to increase and/or decrease the number of historical samples after the initial configuration compared to a linear buffer.

The buffer information provided by the WTRU may be required for configuring per-layer TSF buffers, including the size and/or the number of active buffers. An active buffer may represent a specific per-layer buffer that is configured for active monitoring and storage. The WTRU buffer information may also include the allocation of buffers to different layers (e.g., the first layer may receive the highest allocation of buffer resources). Additionally, this buffer information may influence other CSI feedback configurations, such as criteria used to determine TSF buffer actions.

A wireless transmit/receive unit (WTRU) may report the types of precoding vectors (e.g., spatial-frequency domain, angular and/or delay domain, and/or Doppler domain) that are supported for temporal spatial frequency (TSF) channel state information (CSI) compression. The type of precoding vector may affect the size of each CSI sample, thereby influencing the number of historical CSI samples that may be stored in a per-layer TSF buffer. For example, the dimension of the eigenvectors of the raw channel per layer may be Nₜ×N_{sub-band}, while the dimension of the output of a beam domain processor may be N_{beam}×N_{sub-band} per layer.

The types of supported precoding vectors may be utilized for selection of the precoding vector. The type of precoding vector may affect other CSI feedback configurations, storage and/or memory information, and/or the buffer information.

The configuration of multi-layer TSF buffer management for TSF compression may involve a WTRU capable of performing precoding vector-based CSI compression. This compression may leverage temporal-spatial-frequency domain correlation using precoding vectors such as eigenvectors. The WTRU may receive configuration information associated with the TSF compression operation, which may include WTRU-side TSF buffer parameters, criteria and conditions for determining WTRU-side per-layer TSF buffer actions, and/or reporting configurations for the per-layer TSF buffer actions. The configuration may be received semi-statically (e.g., via RRC configuration) and/or dynamically (e.g., via MAC CE and/or DCI).

The configuration of WTRU-side per-layer TSF buffer parameters may include the WTRU receiving a configuration for one or more per-layer TSF buffers, where each buffer may be associated with a different layer. The configuration of per-layer TSF buffers may include one or more aspects. For example, it may include the type of historical precoding vectors used for CSI generation and/or reconstruction. The type of precoding vectors may represent the linear domain transformation (e.g., pre-processing) of the full (e.g., raw) channel matrix, such as the spatial-frequency domain, angular domain, delay domain, and/or Doppler domain.

The configuration may also specify the number and size of per-layer TSF buffers. For instance, the network (NW) may configure the WTRU for the maximum number of historical samples per buffer or layer. This maximum may be within the WTRU's reported capability and may enable alignment between the NW-side and WTRU-side per-layer TSF buffers. Additionally, the configuration may define the maximum number of per-layer TSF buffers (e.g., N). The maximum number N may be upper-bounded by the WTRU's reported capability, the number of receive antennas, and/or the maximum channel rank supported.

The configuration of WTRU-side per-layer TSF buffer parameters may include the number and indices of active buffers at the WTRU side, wherein an active buffer refers to a per-layer TSF buffer that the WTRU is actively monitoring and updating. For example, while the WTRU may support a high maximum number of per-layer TSF buffers (e.g., N), it may receive configuration to actively monitor and update a smaller number of per-layer TSF buffers (e.g., smaller than N). The configuration may include the default number of active buffers and/or the indices of the active buffers that are to be monitored and updated.

The configuration may include a list of per-layer TSF buffer actions, which may indicate the allowed actions the WTRU may take to update the per-layer TSF buffer as a function of the measured channel conditions and configured criteria. These per-layer TSF buffer actions may include one or more of the following. An A0 action (per-layer TSF buffer reset) may involve performing a full reset (flush) of the per-layer TSF buffer. An A1 action (per-layer TSF buffer update) may allow the WTRU to update the per-layer TSF buffer using the received CSI samples. For example, when the reported rank is low (e.g., rank 1 or 2), this action may enable the WTRU to update higher-layer TSF buffers (e.g., layer 3 or higher TSF buffers). This action may help mitigate missing uplink control information (UCI) errors for subsequent samples, in cases where CSI samples (e.g., eigenvectors) are not received or are received in error at the network (NW) side. An A2 action (per-layer TSF buffer truncate) may allow the WTRU to reset (flush) one or more of the oldest samples in the per-layer TSF buffer. An A3 action (per-layer TSF buffer sample drop) may allow the WTRU to reset (flush) selected samples in the per-layer TSF buffer, where the selected samples may not necessarily be the oldest historical samples.

For correct operation of the NW-side TSF decoder, the WTRU-side and NW-side per-layer TSF buffers may need to be aligned (e.g., synchronized). The WTRU may receive configuration for per-layer TSF buffer monitoring, which may allow alignment or verification of alignment between the WTRU-side and NW-side per-layer TSF buffers. This configuration may include buffer monitoring priority and NW assistance information. If configured, buffer monitoring priority may indicate the monitoring priority of specified per-layer TSF buffers. For example, the WTRU may prioritize monitoring one or more per-layer TSF buffers over others. If no monitoring priority is configured, all layers may be assumed to have equal monitoring priority. NW assistance information may indicate the NW-side action associated with one or more NW-side per-layer TSF buffers. For example, NW assistance information may include an indication of the NW-side per-layer action based on received WTRU feedback and/or the corresponding layer index and/or identifier.

The WTRU may receive configuration for the criteria and/or conditions to determine the WTRU-side per-layer TSF buffer actions. The criteria may involve a comparison between a measurement and a configured threshold, or they may specify a function to evaluate, while the conditions may indicate the associated threshold values. In one solution, the criteria and/or conditions for the WTRU-side per-layer TSF buffer update action may include an indication that the correlation between every pair of contiguous samples in a per-layer TSF buffer may exceed a configured minimum correlation threshold. The criteria and/or conditions may also include an indication that the normalized mean square error (NMSE) between every pair of contiguous samples in a per-layer TSF buffer may be lower than a configured threshold. Additionally, the criteria and/or conditions may include an indication that the correlation between the first and last samples in a per-layer TSF buffer may exceed a configured minimum correlation threshold, and/or an indication that the NMSE between the first and last samples in a per-layer TSF buffer may be lower than a configured threshold.

In some examples, the criteria to determine a WTRU-side per-layer TSF buffer action may be the temporal distance (e.g., measured in milliseconds (ms)) between pairs of CSI samples in the per-layer TSF buffer. For example, when the minimum temporal distance between pairs of samples is below a configured threshold, the WTRU may select the drop action (e.g., A3). When the maximum temporal distance between pairs of samples exceeds a configured threshold, the WTRU may select the reset (e.g., A0) or the update (e.g., A1) action.

The criteria to determine a WTRU-side per-layer TSF buffer action may be the spacing type, where spacing refers to the temporal distance (e.g., in ms) between each pair of consecutive samples in the buffer. The spacing type may be uniform or non-uniform. For a uniform spacing type, all consecutive pairs may be separated by the same temporal distance. For a non-uniform spacing type, some pairs may be separated by a first temporal distance, while other pairs may be separated by a second temporal distance, which may be different from the first temporal distance. Additionally and/or alternatively, the distance between pairs of samples in the buffer may be expressed as a number of measured CSI instances, in slots, and/or in transmission time intervals (TTIs), and may be converted to time domain by considering the CSI-RS periodicity, the slot duration, and/or the TTI duration.

The criteria and/or conditions to determine a WTRU-side per-layer TSF buffer action may be the number of inactive instances (e.g., for the corresponding layer) and/or the corresponding threshold, where an inactive instance may refer to a reporting instance for which the WTRU does not report a value for that layer. For example, when the number of inactive instances exceeds a configured threshold, the WTRU may select the reset (e.g., A0) action. The criteria and/or conditions to determine a WTRU-side TSF buffer action may include metrics for the first layer TSF buffer and/or the corresponding thresholds, where the metrics may be SGCS between samples in buffer, reception quality, and/or reconstruction quality.

The WTRU may receive a reporting configuration for reporting per-layer TSF buffer information and the selected WTRU actions. The configuration may include resources for reporting the determined per-layer TSF buffer actions and/or the associated layer identifier (ID) for the determined action. The configuration may further include resources for reporting the metrics that triggered a new WTRU action.

The configuration may specify the periodicity of the reports. For example, in the case of periodic reports, the WTRU may receive configuration for the number of slots, TTIs, and/or ms between consecutive reports. The configuration may define rules for dropping a report. For example, the rules for dropping a report may apply when the report is scheduled on the physical uplink shared channel (PUSCH) and/or higher priority CSI feedback is scheduled on the same resources.

In examples, the WTRU may make a determination of TSF buffer actions based on one or more conditions and/or rules. The WTRU may be configured with a two-sided AIML model for TSF CSI compression, where a CSI generation part may be generated using an AIML encoder model at the WTRU while the CSI reconstruction may be performed using an AIML decoder model at the NW. For TSF compression, the past CSI and/or a representation thereof may be used as an input to the AIML encoder model at the WTRU. The past reconstructed CSI and/or a representation thereof may be used as an input to the AIML decoder model at the NW. The term past CSI samples may be used to indicate the historical precoding vectors (e.g., eigenvectors) at the WTRU side and/or the historical reconstructed precoding vectors at the NW side. The precoding vectors may be represented in one or more of a plurality of domains. These domains may include, for example, a spatial-frequency domain, beam-frequency domain, spatial-delay domain and/or a beam-delay domain. The term per-layer TSF buffers may indicate the buffer associated with storing the per-layer WTRU-side and/or NW-side past CSI samples. For proper TSF operation, the per-layer WTRU-side TSF buffer and the per-layer NW-side TSF buffer may need to be in sync (e.g., number and/or indices of past CSI samples stored at the WTRU side may need be synchronized with the number and/or indices of past CSI samples stored at the WTRU side). To optimize the TSF CSI compression, the per-layer TSF buffers may need to operate at nearly full capacity to leverage the usage of the past CSI samples in the compression process (e.g., the TSF buffers may need to consistently have a sufficient number (e.g., at least 50% of the buffer capacity, the configured observation window length, and/or channel coherence time of samples) may be a sufficient number for efficient TSF operation.

The WTRU may be configured to determine one or more per-layer TSF buffer actions to ensure appropriate use of the past CSI, may result in a more efficient TSF compression operation. The per-layer buffer actions may include one or more of resetting, actively updating, truncating, and/or dropping. Each layer buffer may be handled independently and the determined per-layer action may be reported to the NW to maintain synchronization between the WTRU-side buffer and the NW-side buffer. The per-layer determined action may be based on one or more of the received configurations. For example, the WTRU may determine Action A₀ (e.g., a full reset of the buffer) for a specific layer when one or more of the following conditions are satisfied.

The conditions may include a number of consecutive inactive instances which exceed a configured threshold, where an inactive instance may refer to a per-layer buffer state in which the corresponding layer may not be scheduled for reporting. For example, a specific layer may be scheduled for CSI reporting at time Tⱼ but not scheduled for CSI reporting at time Tⱼ₊₁, Tⱼ₊₂, may result in two consecutive inactive instances. The conditions may include a performance associated with a specific layer falling below a first threshold (e.g., block error rate (BLER), reference signal received power (RSRP), and/or signal-to-interference-plus-noise ratio (SINR)); a missing uplink control information (UCI) event being detected; and or random correlation behavior being observed across the stored samples (e.g., a correlation between pairs of consecutive samples fluctuates with a variance greater than a threshold).

The WTRU may determine Action A₁ (e.g., actively update the buffer) for a specific layer when one or more of the following conditions is satisfied. The conditions may include that there is consistency in the correlation behavior over time even when a specific layer has one or more inactive instances. For example, a specific layer (e.g., layer 2) may be absent from reporting at time Tⱼ but the correlation between the associated reported CSI samples in Tⱼ₋₁ and Tⱼ₊₁ exceeds a configured threshold. In this instance, the WTRU may determine Action A₁ for layer 2, implying that the absence of the CSI sample at Tⱼ may not impact the TSF performance of that layer. The conditions may include that any of the layer's CSI may be continuously active and/or reported over time (e.g., Layer 1).

The WTRU may determine Action A₂ (e.g., truncate the sample in the buffer by removing the K-oldest samples) for a specific layer, when one or more of the following conditions is satisfied. The conditions may include that the correlation between the K-oldest sample and the newest sample in the buffer may be below a threshold, in which the WTRU may flush the oldest K samples. This implies that the first K CSI samples may not be effective in generating the current sample. The conditions may include that the WTRU runs out of memory associated with a specific layer/buffer or total memory budget.

The WTRU may determine Action A₃ (e.g., drop one or more samples from the buffer) for a specific layer when one or more of the following conditions is satisfied. The conditions may include that the WTRU may maintain a configured spacing type across each of the samples in the buffer. A spacing type may indicate whether the samples in the buffer may be equally spaced in terms of temporal distance (e.g., in ms), or whether non-uniform spacing is allowed between the samples in the buffer. The spacing type may be either uniform or non-uniform. For example, if the WTRU has the following sample indices in the buffer (e.g., 0, 1, 2, 4), then the WTRU may choose to drop sample number 1 to maintain a uniform spacing between the samples in the buffer, assuming a constant CSI-RS periodicity. The uniform spacing may result in better TSF performance relative to the non-uniform spacing.

The WTRU may make a determination of TSF buffer actions (e.g., with WTRU-side decoder available) based on L1 measurements. The WTRU may determine the TSF per-layer buffer actions based on the performance associated with the first layer reconstruction error under intentionally dropped samples using the active WTRU-side encoder-decoder model. For example, let S={H_{t-N}, H_{t-N+1}, . . . , Hₜ} denote a set of channel samples in the first layer buffer ending at time t, where N is the length of the buffer. Let M be a binary mask applied to S where Mᵢ=0/1 indicates that sample H_{t-N+i} is dropped or retained (e.g., the per layer buffer sample indices to drop or retain. Let S_{dropped} be the result of applying S(M) (e.g., the resultant first layer buffer after performing the buffer action). The WTRU may then compute Ĥ_{t,dropped}=D(E(S_{dropped})) and Ĥ_{t,not-dropped}=D(E(S)) to evaluate the reconstruction errors: L(Hₜ, Ĥ_{t,dropped}) and L(Hₜ, Ĥ_{t,not-dropped}).

The WTRU may determine Action A₂ for the n^{th} layer buffer, n>1, when any of the following conditions is satisfied on the first layer buffer. The conditions may include that the WTRU has selected the K buffer samples indices to drop, which may be associated with the K oldest samples in the buffer. The conditions may include that the reconstruction error with the dropped samples, L(Hₜ, Ĥ_{t,dropped}) is lower than the reconstruction error without the dropped samples, L(Hₜ, Ĥ_{t,not-dropped})

The WTRU may determine Action A₃ for the n^{th} layer, n>1 when one or more of the following conditions is satisfied on the L1 buffer. The conditions may include that the WTRU has selected the per-layer buffer indices to drop such that uniform spacing type is preserved, where the spacing type may be uniform, non-uniform, or a mix of both. The conditions may include that the reconstruction error with the dropped samples, L(Hₜ, Ĥ_{t,dropped}) is lower than the reconstruction error without the dropped samples, L(Hₜ, Ĥ_{t,not-dropped}).

The WTRU may make a determination of a window for evaluation of buffer actions. The WTRU may need to estimate the reconstruction performance at time t+1 (e. g., L(Hₜ₊₁, Ĥ_{t,+1}) when determining the per-layer buffer action at time t. However, the channel sample at time t+1 may not be available to the WTRU at time t. The WTRU may select a historical window of contiguous samples that closely resembles the current temporal dynamics. The WTRU may use samples from the selected historical window to perform inference to evaluate the impact of the buffer action on the reconstruction performance. For example, the WTRU may select the nearest historical window S={H_{t-N}, H_{t-N+1}, . . . , Hₜ} to compute L(Hₜ, Ĥₜ) as a estimate for L(Hₜ₊₁, Ĥ_{t,+1}). The WTRU may select a sequence further in the past according to some similarity metric (e.g. cross correlation, average SGCS, and/or NMSE between successive samples). The WTRU may be configured with an AI/ML-based or non-AI/ML-based (e.g. Kalman Filter) model to compute a prediction of the L1 channel at a next time instance. The WTRU may compute L(H_{pred}, Ĥ_{pred}) as a proxy for L(Hₜ₊₁, Ĥ_{t,+1}).

In examples, the WTRU may determine TSF buffer actions without a WTRU-side AI/ML decoder. The WTRU may be configured with one part of a two-sided AIML model for TSF CSI compression, where the CSI generation part may be generated using an AIML encoder. The terms compressed channel and latent vector may be used interchangeably to denote the output of the CSI generation part. The WTRU may determine the TSF per-layer buffer actions under intentionally dropped per-layer buffer samples in one or more layers using the active WTRU-side encoder. For example, let S={H_{t-N}, H_{t-N+1}, . . . , Hₜ} denote a set of channel samples in the L1 buffer ending at time t, where N is the length of the buffer. Let M be a binary mask applied to S where Mᵢ=0/1 indicates that sample H_{t-N+i} is dropped or retained (e.g., the per layer buffer indices to drop or retain). Let S_{dropped} be the result of applying S(M) (e.g., the resultant L1 buffer) after implementing the buffer action. The WTRU may then compute the compressed channel V_{t,dropped}=E(S_{dropped}) and V_{t,not-dropped}=E(S).

The WTRU may determine Action A₂ for the n^{th} layer, n>1, buffer when the following conditions are satisfied on the first layer buffer. The conditions may include that the WTRU has selected the K buffer indices to drop, which may be associated with the K oldest samples in the buffer; and/or that the correlation between V_{t,dropped} and historical compressed channels may be greater than the correlation between V_{t,not-dropped} and the historical compressed channels.

The WTRU may determine Action A₃ for the n^{th} layer, n>1 when one or more of the following conditions are satisfied on the first layer buffer. The conditions may include that the WTRU has selected the per-layer buffer indices to drop such that uniform spacing type may be preserved, where the spacing type may be uniform, non-uniform or a mix of both; and/or that the correlation between V_{t,dropped} and historical compressed channels may be greater than the correlation between V_{t,not-dropped} and the historical compressed channels.

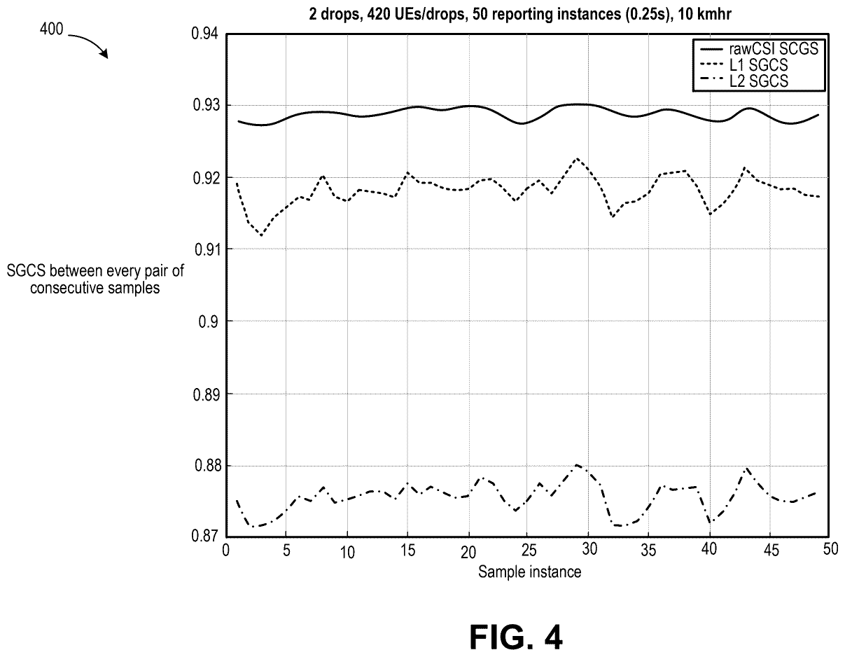

Referring now to FIG. 4, a diagram 400 showing an example of temporal behavior of a sequence of correlated samples is illustratively depicted. The diagram 400 includes results that indicate that different layers may have different temporal dynamics. To show that the n-th layer, for n>1, may obtain an appropriate action based on first-layer-related measurements, an example of temporal behavior in terms of the correlation between consecutive samples is illustrated in FIG. 4. The illustration shows that the temporal behavior of both the first layer and the second layer may be similar. This implies that the temporal behavior of the first layer may be utilized to infer the actions associated with the second layer.

A WTRU may report one or more TSF buffer actions for one or more transmission layers (e.g., to synchronize with the gNB). A reported action may include any of the plurality of actions described herein (e.g., reset, actively update, truncate, and/or drop). A reported action may include an indication that there has been, and/or has not been a change for one or more layers. A reported action may include an index. The reported index may point to an element in a table of possible per-layer TSF buffer actions. The table of possible per-layer TSF buffer actions may be fixed and/or may be configurable. A WTRU may receive a configuration for a table of possible per-layer TSF buffer actions via RRC configuration, DCI, and/or MAC-CE.

A WTRU may be triggered to report TSF buffer actions. The triggers may be determined by the WTRU and/or may be received by the WTRU in an indication transmitted from, for example, the gNB. The triggers to report TSF buffer actions may include one or more of a plurality of triggers. For example, the triggers for the WTRU to report TSF buffer actions may include periodic reporting, in which the WTRU may be configured with periodic resources to report one or more TSF buffer actions for one or more transmission layers. The WTRU may report one or more buffer actions for one or more transmission layers in a CSI feedback report that may include the CSI feedback for the one or more transmission layers. The WTRU may report one or more buffer actions for one or more transmission layers every n-th CSI feedback report, where n may be configurable. Each transmission layer may have a different value of n. The WTRU may report a TSF buffer action for a first layer (e.g., every n=1) CSI feedback report, and the WTRU may report a TSF buffer action for a second layer (e.g., every n=5) CSI feedback reports.

The triggers may include aperiodic reporting, in which a WTRU may be triggered to report one or more TSF buffer actions for one or more transmission layers by a request (e.g., received from the gNB). The request may be a dedicated request to report one or more TSF buffer actions. The request may be a request to report aperiodic CSI feedback. The WTRU may multiplex the one or more TSF buffer actions to the aperiodic CSI feedback report.

The triggers may include semi-persistent reporting, in which a WTRU may be triggered to report one or more TSF buffer actions for one or more transmission layers by a request (e.g., received from the gNB) which may be applicable for one or more future reporting instances. The WTRU may receive an indication of the number, identity, and/or timing of the future reporting instances where the WTRU may be triggered to report one or more TSF buffer actions. A WTRU may receive a trigger to begin and/or a trigger to stop reporting one or more TSF buffer actions.

The triggers may be based on one or more specific buffer actions. For example, the WTRU may report one or more TSF buffer actions based on the action itself. The WTRU may report a TSF buffer action when it is, for example, a reset action. In examples in which the WTRU determines that one or more transmission layer has a specific (and possibly configurable), the WTRU may report one or more (or all) TSF buffer actions for one or more (or all) transmission layers.

The triggers may be based on a change in a TSF buffer action. For example, the WTRU may report one or more TSF buffer actions if the action has changed since a previous report of the one or more TSF buffer actions. The WTRU may report only the TSF buffer actions for transmission layers where the action has changed from a previous report. In examples in which at least one TSF buffer action has changed for at least one transmission layer, the WTRU may report one or more TSF buffer actions for all transmission layers. Additionally, the WTRU may be configured with one or more anchor transmission layers. Upon determining a change in TSF buffer actions for the one or more anchor transmission layers, the WTRU may report the TSF buffer actions for one or more transmission layers. For instance, an anchor transmission layer may be the first transmission layer.

The triggers may be based on the time elapsed since the last report of TSF buffer actions. For example, the WTRU may report one or more TSF buffer actions based on the time elapsed (e.g., measured in ms, slots, symbols, and/or subframes) since the last report of the TSF buffer actions. For instance, the WTRU may report a TSF buffer action for a transmission layer if the time since the last report of a TSF buffer action for that transmission layer exceeds a possibly configurable value. In examples in which the time since the last report of any TSF buffer action for any transmission layer exceeds a possibly configurable value, the WTRU may report one or more TSF buffer actions for all transmission layers.

The triggers may be based on a measurement. For example, the WTRU may report one or more TSF buffer actions based on a measurement, possibly associated with the determination of TSF buffer actions. For instance, the WTRU may determine whether to report one or more TSF buffer actions based on a determined CSI value (e.g., a value input to the TSF AIML model or a value outputted from the TSF AIML model). The measurement may include at least one of a Rank Indicator (RI), Channel Quality Indicator (CQI), Precoding Matrix Indicator (PMI), Layer Indicator (LI), Received Signal Strength Indicator (RSSI), Reference Signal Received Power (RSRP), Signal-to-Interference-plus-Noise Ratio (SINR), Angle of Arrival (AoA), and/or Angle of Departure (AoD), Doppler spread, Doppler shift, average delay, and/or delay spread. The WTRU may report one or more TSF buffer actions based on the RI or the set of transmission layers for which measurements are being reported. In examples in which one or more measurements have changed since the last report of that measurement, the WTRU may report one or more TSF buffer actions. The WTRU may report one or more TSF buffer actions when a newly determined RI value is different from (e.g., is greater than, or is less than) a previously (or last) reported RI value.

The triggers may be based on a performance criterion. For example, the WTRU may determine or be indicated the performance of TSF-based CSI reporting. The WTRU may determine whether to report one or more TSF buffer actions based on the TSF-based CSI reporting performance, which may be compared to a threshold. The WTRU may determine the performance of TSF-based CSI reporting based on one or more factors, such as a transmission performance (e.g., HARQ-ACK value and/or HARQ-ACK NACK rate), a received value from the gNB (e.g., a value used to compare the expected output of TSF-based compression to the actual output), and/or a scheduling parameter (e.g., MCS and/or PMI). The triggers may be based on the gNB's current and/or updated TSF buffer actions.

A TSF buffer reporting method may include a WTRU reporting one or more TSF buffer actions. The WTRU may report one or more of one or more TSF buffer actions and/or an index thereof; an associated transmission layer for each of the one or more TSF buffer actions; and/or an indication of whether one or more TSF buffer actions is the same or different from a previous report. The WTRU may request that the gNB report the gNB's current, previous, and/or updated TSF buffer actions and/or buffer status. The WTRU may be configured with resources to report one or more TSF buffer actions. For example, the WTRU may have dedicated UL resources (e.g., PUCCH) to report one or more TSF buffer actions, and/or the WTRU may multiplex the reported one or more TSF buffer actions into another transmission (e.g., UCI, UCI on PUCCH, UCI on PUSCH).

The WTRU may multiplex a report for one or more TSF buffer actions in a transmission that may include CSI generated using the reported one or more TSF buffer actions. The WTRU may multiplex a report for one or more TSF buffer actions in a transmission that may include CSI generated using a previously reported one or more TSF buffer actions. In such a case, the newly reported TSF buffer actions may be used to generate a subsequent CSI report. A WTRU may determine a priority of a report that may include one or more updated TSF buffer actions. The priority may depend on the presence of one or more TSF buffer actions, the reported values of the one or more TSF buffer actions, and/or the associated CSI report and/or report type.

Table 1 shows an illustration of existing state-of-the-art WTRU actions associated with handling the TSF buffers relative to the new actions described herein as a function of variable reported rank. PG

TABLE 1

| Buffer/time | | | | | |
|---|---|---|---|---|---|
| index | T₀ | T₁ | T₂ | T₃ | T₄ |
| L1-buffer | V₁ (0)/\hat{V}₁ (0) | V₁ (1)/\hat{V}₁ (1) | V₁ (2)/\hat{V}₁ (2) | V₁ (3)/\hat{V}₁ (3) | V₁ (4)/\hat{V}₁ (4) |
| L2-buffer | V₂ (0)/\hat{V}₂ (0) | V₂ (1)/\hat{V}₂ (1) | V₂ (2)/\hat{V}₂ (2) | V₂ (3)/— | V₂ (4)/\hat{V}₂ (4) |
| L3-buffer | V₃ (0)/\hat{V}₃ (0) | V₃ (1)/— | V₃ (2)/\hat{V}₃ (2) | V₃ (3)/— | V₃ (4)/\hat{V}₃ (4) |
| L4-buffer | V₄ (0)/\hat{V}₄ (0) | V₄ (1)/— | V₄ (2)/— | V₄ (3)/— | V₄ (4)/\hat{V}₄ (4) |
| Reported RI | 4 | 2 | 3 | 1 | 4 |
| pattern | | | | | |
| Legacy | | L3 and L4 → | | L2 → A0 | |
| Action | | A0 | | L3 → A0 | |
| New Action | | | | | |
| A0 Reset | L1, . . . , | L1 → A1 | | L1 → A1 | |
| A1 Actively | L4 → A1 | L2 → A1 | | L2 → A3 | |
| update | | L3 → A1 | | L3 → A2 | |
| A2 Truncate | | L4 → A0 | | L4 → A1 | |
| A3 Drop | | | | | |

Table 1 provides an example of the new actions described herein, as associated with the EV-based TSF buffer management relative to legacy action (e.g., A0—full buffer reset) as a function of the reported rank pattern. For example, for layer 3 (L3) buffer, there may be three inactive instances, which implies that A₀ may be an appropriate action. In another example, for a layer 2 (L2) buffer, at T3, the WTRU may determine A1 if the WTRU determines, based on some measurements, that the absence of the CSI at T3 is ineffective, and/or the WTRU may determine to drop the CSI at T2 to maintain uniform spacing between the samples. For a layer 1 (L1) buffer, the WTRU may determine an A2 action to flush the K oldest samples either to satisfy a memory constraint or due to the K oldest sample becoming in effective in deriving the current compressed CSI.

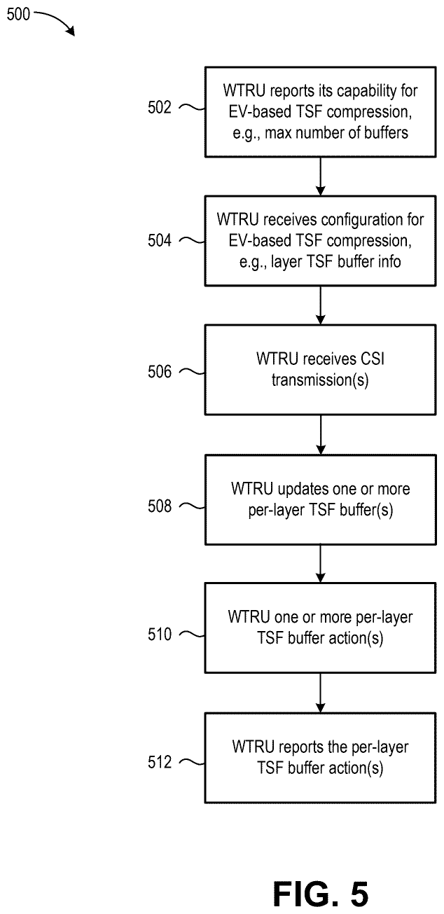

Referring now to FIG. 5, a flow diagram 500 showing example wireless transmit/receive unit (WTRU) procedures for eigenvector (EV)-based Temporal-Spatial-Frequency (TSF) compression with variable rank reporting is illustratively depicted. WTRU procedures for multi-layer buffer management for EV-based TSF compression with rank adaptation are illustratively depicted in FIG. 5.

At 502, the WTRU may report its capability for precoding vector-based TSF compression (e.g., eigenvectors). The reported capability may include the total number of storage and/or memory units for each of the layers, the maximum number of storage and/or memory units per layer, and/or the maximum number of TSF buffers to support, handle, and/or monitor.

At 504, the WTRU may receive a configuration for CSI feedback based on TSF compression using past precoding vectors employed at both the NW and the WTRU in the compression process (e.g., via an AE model). The configuration may include a WTRU-side TSF buffer parameter configuration, such as one or more per-layer TSF buffers associated with different layers. The WTRU-side buffer parameter configuration may include parameters representing the type of historical precoding vectors used for CSI generation and/or reconstruction, where the type of historical samples may represent the spatial-frequency domain, angular domain, delay domain, and/or Doppler domain.

The WTRU-side TSF buffer parameter configuration may include the number and/or indices of active buffers at the WTRU side, where an active buffer may refer to a per-layer TSF buffer actively monitored and/or updated by the WTRU. The total number of per-layer TSF buffers (denoted as N) may be upper-bounded by the number of receive antennas, the NW configuration, and/or the maximum rank. The WTRU-side buffer parameter configuration may define the maximum number of historical samples per buffer and/or layer, the maximum number of layers and/or buffers, and/or the default number of active buffers. Per-layer TSF buffer actions may be configured and may include, for example, an A0 action (e.g., reset) to fully flush the buffer, an A1 action to actively update the buffer with useful samples (e.g., mitigating missing UCI errors when samples are not received or are received in error at the NW side), an A2 action to truncate one or more of the oldest samples in the buffer, and/or an A3 action to drop selected samples for certain layers, where the dropped samples may not necessarily be the oldest.

The WTRU-side buffer parameter configuration may specify per-layer TSF buffer monitoring parameters. To ensure proper TSF compression, enabling alignment of WTRU-side TSF synchronization with NW-side TSF synchronization, the WTRU-side TSF sync information may be aligned with the NW-side TSF sync information. The WTRU-side buffer parameter configuration may include a buffer monitoring priority, which may indicate that the WTRU may prioritize monitoring one or more per-layer TSF buffers over others. The WTRU-side buffer parameter configuration may include NW assistance information, which may indicate an output of a NW action associated with one or more of the NW-side per-layer TSF buffer(s) information (e.g., an indication of the NW-side per-layer TSF buffer action based on received WTRU feedback).

Criteria and/or conditions to determine WTRU-side per-layer TSF buffer actions may be included in the configuration. The criteria and/or conditions may include, for example, a minimum correlation and/or NMSE threshold between each pair of contiguous samples in a per-layer TSF buffer; a minimum correlation and/or NMSE threshold between each first and last samples in a per-layer TSF buffer; and/or a minimum and/or maximum distances (e.g., in ms) between each pair of samples in a per-layer TSF buffer. The criteria and/or conditions may include a spacing type (e.g., uniform and/or non-uniform spacing between samples in a per-layer TSF buffer); a number of inactive instances required to reset; metrics for the first layer TSF buffer (e.g., Layer-1 performance, SGCS between samples in the buffer, reception quality, reconstruction, under intentionally dropped samples, and/or RSRP and/or SINR thresholds. A reporting configuration may also be included in the WTRU configuration, which may include, for example, uplink (UL) resources for per-layer TSF buffer information.

At 506, the WTRU may receive one or more CSI-RS transmissions. At 508, the WTRU may update one or more WTRU-side per-layer TSF buffers based on one or more received CSI-RS transmissions and/or one or more configuration parameters (e.g., buffer monitoring priority and/or NW assistance information).

At 510, the WTRU may determine one or more per-layer TSF buffer actions (e.g., A0, A1, A2, and/or A3) based on the updated WTRU-side per-layer TSF buffers and/or the received configuration. For example, the WTRU may determine an A0 action based on the number of inactive instances for each layer compared to a threshold and/or based on an RSRP and/or SINR measurement. The WTRU may determine an A1 action based on the measured correlation and/or NMSE between contiguous samples evaluated against a threshold, and may select A1 if the measured value is higher than the threshold. The WTRU may determine an A2 action based on the measured correlation and/or NMSE between the first and last samples evaluated against a threshold, and may select A2 if the measured value is below the threshold. The WTRU may determine an A1 action as a function of the rank pattern, and may select A1 if no change in the rank pattern occurs over a period of time. The WTRU may determine an A3 action as a function of the configured spacing type (e.g., uniform and/or non-uniform), and may select A3 if uniform spacing is needed. The WTRU may determine actions as a function of Layer-1 buffer-related measurements, such as the impact of intentionally dropped samples from the buffer to mimic the behavior of other layers and/or evaluate the resulting impact.

At 512, the WTRU may report the determined per-layer TSF buffer actions. The WTRU may report periodically, where the report may be indicated for each of n configured periods. The WTRU may multiplex the report with a TSF compressed report (e.g., a TSF compressed report obtained using one or more updated WTRU-side per-layer TSF buffers). Reporting may occur when one or more conditions are satisfied (e.g., a rank value update and/or a per-layer performance dropping below a threshold). The WTRU may report upon a change of one or more per-layer TSF buffer actions from one or more previously reported per-layer buffer actions.

1. A wireless transmit/receive unit (WTRU) comprising:
a processor configured to:
receive a temporal-spatial-frequency (TSF) buffer configuration associated with multi-layer buffer management for a plurality of buffers for eigenvector-based TSF channel state information (CSI) compression, wherein the TSF buffer configuration comprises a plurality of TSF buffer actions and conditions associated with the plurality of TSF buffer actions, wherein the plurality of TSF buffers comprise one or more per-layer TSF buffers;
receive CSI-reference signal (RS) transmissions associated with one or more transmission layers;
update the plurality of buffers based on the CSI-RS transmissions;
determine a TSF buffer action for each of the plurality of buffers based on the TSF buffer configuration; and
send an indication of the TSF buffer action for each of the plurality of buffers.

2. The WTRU of claim 1, wherein the TSF buffer configuration comprises TSF buffer monitoring parameters, and wherein the processor is configured to:
update the plurality of buffers based on the CSI-RS transmissions and the TSF buffer monitoring parameters.

3. The WTRU of claim 2, wherein the TSF buffer monitoring parameters comprise a buffer monitoring priority associated with the plurality of buffers or assistance information that indicates an output of a network action associated with network-side TSF buffer information.

4. The WTRU of claim 1, wherein the plurality of TSF buffer actions comprise a reset action and at least one of an active update action, a truncate action, or a drop action, wherein the processor is configured to:
flush stored samples in each of the plurality of buffers to perform the reset action;
incorporate newly received CSI samples into each of the plurality of buffers, wherein previously stored samples are retained, to perform the active update action;
remove one or more oldest samples from each of the plurality of buffers to perform the truncate action; and
remove one or more selected samples from each of the plurality of buffers, wherein the removed samples are not the one or more oldest samples, to perform the drop action.

5. The WTRU of claim 1, wherein the processor is configured to send the indication of the TSF buffer action for each of the plurality of buffers periodically or upon detecting a change in the TSF buffer actions.

6. The WTRU of claim 1, wherein the conditions associated with the plurality of TSF buffer actions comprise at least one of:
a minimum correlation or normalized mean square error (NMSE) threshold between each pair of contiguous samples in each of the plurality of buffers;
a minimum correlation or NMSE threshold between a first sample and a last sample in each of the plurality of buffers;
a minimum or maximum temporal distance between each pair of samples in each of the plurality of buffers;
a spacing type for samples in each of the plurality of buffers, wherein the spacing type is uniform or non-uniform;
a number of inactive instances to trigger a reset action for one or more of the plurality of buffers;
one or more metrics for a first layer TSF buffer; or
a reference signal received power (RSRP) or signal-to-interference-plus-noise ratio (SINR) threshold associated with each of the plurality of buffers.

7. The WTRU of claim 1, wherein the processor is configured to determine the plurality of TSF buffer actions based on at least one of:
a correlation threshold between contiguous samples in the plurality of TSF buffers;
a correlation threshold between first and last samples in the plurality of TSF buffers;
a configured spacing type for samples in the plurality of TSF buffers, wherein the spacing type is uniform or non-uniform; or
a number of inactive instances associated with the plurality of TSF buffers.

8. The WTRU of claim 1, wherein the processor is configured to update the plurality of TSF buffers by at least one of truncating one or more oldest samples in the plurality of TSF buffers, or dropping one or more selected samples in the plurality of TSF buffers, wherein the selected samples are not the oldest samples.

9. The WTRU of claim 1, wherein the processor is configured to:
report the TSF buffer action periodically, at a configured interval, and
report the TSF buffer action upon determining a change in a TSF buffer action for at least one layer.

10. The WTRU of claim 1, wherein the processor is configured to multiplex the TSF buffer action with a TSF compressed report.

11. A method implemented by a wireless transmit/receive unit (WTRU), the method comprising:
receiving a temporal-spatial-frequency (TSF) buffer configuration associated with multi-layer buffer management for a plurality of buffers for eigenvector-based TSF CSI compression, wherein the TSF buffer configuration comprises a plurality of TSF buffer actions and conditions associated with the plurality of TSF buffer actions, wherein the plurality of TSF buffers comprise one or more per-layer TSF buffers;
receiving channel state information (CSI) reference signal (RS) transmissions associated with one or more transmission layers;
updating the plurality of buffers based on the CSI-RS transmissions;
determining a TSF buffer action for each of the plurality of buffers based on the TSF buffer configuration; and
sending an indication of the TSF buffer action for each of the plurality of buffers.

12. The method of claim 11, further comprising updating the plurality of buffers based on the CSI-RS transmissions and TSF buffer monitoring parameters, wherein the TSF buffer configuration comprises the TSF buffer monitoring parameters.

13. The method of claim 12, wherein the TSF buffer monitoring parameters comprise a buffer monitoring priority associated with the plurality of buffers or assistance information that indicates an output of a network action associated with network-side TSF buffer information.

14. The method of claim 11, wherein the plurality of TSF buffer actions comprise a reset action and at least one of an active update action, a truncate action, or a drop action, and wherein:
the reset action comprises flushing stored samples in each of the plurality of buffers;
the active update action comprises incorporating newly received CSI samples into each of the plurality of buffers, wherein previously stored samples are retained;
the truncate action comprises removing one or more oldest samples from each of the plurality of buffers; and
the drop action comprises removing one or more samples from each of the plurality of buffers, wherein the removed samples are not the one or more oldest samples.

15. The method of claim 11, further comprising sending the indication of the TSF buffer action for each of the plurality of buffers periodically or upon detecting a change in the TSF buffer actions.

16. The method of claim 11, wherein the conditions associated with the plurality of TSF buffer actions comprise at least one of:
a minimum correlation or normalized mean square error (NMSE) threshold between each pair of contiguous samples in each of the plurality of buffers;
a minimum correlation or NMSE threshold between a first sample and a last sample in each of the plurality of buffers;
a minimum or maximum temporal distance between each pair of samples in each of the plurality of buffers;
a spacing type for samples in each of the plurality of buffers, wherein the spacing type is uniform or non-uniform;
a number of inactive instances to trigger a reset action for one or more of the plurality of buffers;
one or more metrics for a first layer TSF buffer; or
a reference signal received power (RSRP) or signal-to-interference-plus-noise ratio (SINR) threshold associated with each of the plurality of buffers.

17. The method of claim 11, wherein determining the plurality of TSF buffer actions comprises determining the plurality of TSF buffer actions based on at least one of:
a correlation threshold between contiguous samples in the plurality of TSF buffers;
a correlation threshold between first and last samples in the plurality of TSF buffers;
a configured spacing type for samples in the plurality of TSF buffers, wherein the spacing type is uniform or non-uniform; or
a number of inactive instances associated with the plurality of TSF buffers.

18. The method of claim 11, wherein updating the plurality of TSF buffers comprises at least one of:
truncating one or more oldest samples in the plurality of TSF buffers; or
dropping one or more selected samples in the plurality of TSF buffers, wherein the selected samples are not the oldest samples.

19. The method of claim 11, further comprising:
reporting the TSF buffer action periodically, at a configured interval; or
reporting the TSF buffer action upon determining a change in a TSF buffer action for at least one layer.

20. The method of claim 11, further comprising multiplexing the TSF buffer action with a TSF compressed report.
